(19) United States
(12) Patent Application Publication
(10) Pub. No.: US 2008/0042936 A1
(43) Pub. Date: Feb. 21, 2008

(54) METHOD FOR PROCESSING DISPLAY SIGNALS OF LIGHT-EMITTING MODULE STRING AND RELATED DISPLAY SYSTEM

(76) Inventor: Tsun-I Wang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/738,515

(22) Filed: Apr. 22, 2007

(30) Foreign Application Priority Data
Aug. 16, 2006 (TW) 095130140

(51) Int. Cl. G09G 3/30

(52) U.S. Cl. 345/76

(57) ABSTRACT

Utilizing a single signal line to transmit a display signal to a light emitting module string, a first light-emitting module of the light emitting module string receives and updates the display signal, and transmits the updated display signal to a second light-emitting module. Finally, the display signal is transmitted to the last light-emitting module of the light emitting module string. Each light-emitting module of the light-emitting module string includes a logic circuit for transmitting, receiving, and updating the data of the display signal. The display signal is transmitted from the first light-emitting module to the last light-emitting module. Therefore, each logic circuit is the same.

### BACKGROUND OF THE INVENTION

1. Field of the Invention

The present invention relates to a method for processing display signals of a light-emitting module string, and more particularly, to a method that utilizes a single signal line to transmit the display signals to the light-emitting module string.

2. Description of the Prior Art

In general, a light-emitting diode (LED) screen utilizes pulse width modulation (PWM) data to control brightness, and the LEDs are driven by a steady current source. The LED screen has high resolution with pixels numbering from 10s of thousands to 1000s of thousands. To display an image, the LED screen is therefore divided into a plurality of display modules. For example, a display module may cover a 32×32 (1024) pixel region, and a screen with 256×192 resolution would be formed of 48 (8*6) display modules. Each pixel module has a red LED, a green LED, and a blue LED, so each display module has 3072 LEDs (1024*3). A plurality of field programmable gate arrays (FPGA) utilize the PWM signals to control the LEDs. Basically, each control signal utilized by the FPGA takes 32 pixels as an address for controlling the LEDs; in other words, the control signals are processed in parallel. Thus, control lines for transmitting the control signals are very complicated, and using a single control line is impossible. Therefore, the LED screen according to the prior art is manufactured with a multi-layer circuit board to implement the complicated control lines. Another method for controlling the LEDs is connecting the LEDs to two electric wires in series or in parallel. Take decorative lamp strings, for example. All LEDs of the lamp string can flash light on and off at the same time, but no LED can be controlled independently, so the lamp strings cannot form a display screen. To control brightness of each LED of the LED string independently requires many control lines, such as PWM signal lines, vertical synchronize signal lines, address lines, clock signal lines, and latch signal lines. So the many control lines necessary for controlling each LED of the LED string independently are very complicated.

### SUMMARY OF THE INVENTION

The present invention provides a method for processing display signals of a light-emitting module string comprising providing a light-emitting module string having a plurality of light-emitting modules connected in series; transmitting a display signal having a plurality of display data to a first light-emitting module of the light-emitting module string; the first light-emitting module receiving a first display datum of the display signal; updating the first display datum of the display signal; and transmitting a result of updating the first display datum to a second light-emitting module of the light-emitting module string.

The present invention provides a display system capable of processing display signals of a light-emitting module string comprising a screen comprising a plurality of light-emitting module strings, each light-emitting module string comprising a plurality of light-emitting modules connected in series; and a display signal controller coupled to the plurality of light-emitting module strings for transmitting a display signal having a plurality of display data to a first light-emitting module of the light-emitting module string; wherein each first light-emitting module of the light-emitting module string comprises means for updating a first display datum of the display signal after receiving the first display datum of the display signal, and transmitting a result of updating the first display datum of the display signal to a next light-emitting module connected in series.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a display signal according to the present invention.

FIG. 2 is a diagram of a display system according to the present invention.

FIG. 3 is block diagram of a light-emitting module in FIG. 2.

FIG. 4 is a waveform diagram of signals in FIG. 3.

FIG. 5 is a diagram of a light-emitting module transmitting the display signal.

### DETAILED DESCRIPTION

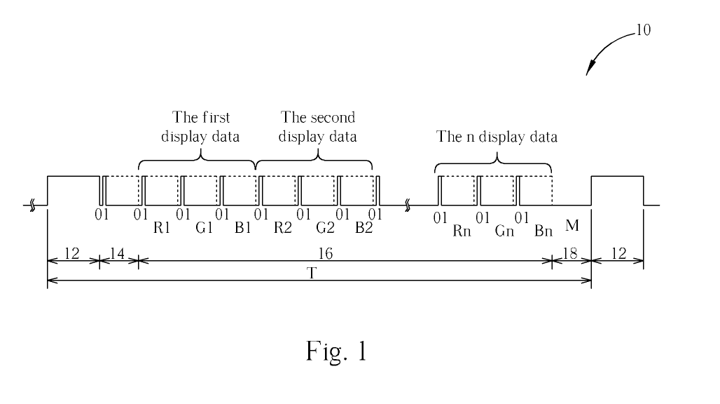

Please refer to FIG. 1. FIG. 1 is a diagram of a display signal 10 according to the present invention. The display signal 10 includes a start datum 12, a characteristic sign “01”, a pre-scalar datum 14, a plurality of display data 16, and an end datum 18. In the preferred embodiment, the data is represented in positive logic. When the data is represented in negative logic, “0” and “1” are exchanged. The start datum 12 is defined as 16 successive 1's for determining if the start datum 12 is received correctly, because no other data in the display signal 10 has 16 successive 1's. The start datum 12 not only indicates the beginning of the display signal 10, but also synchronizes the display signal 10, that is, the vertical synchronize signal, for representing a frame time T between two start data 12. The pre-scalar datum 14 has 10 bits following the characteristic sign “01” to form a 12-bit datum. No matter what the pre-scalar datum 14 is, at most only 11 successive 1's exist, so the start datum 12 can be easily identified. In addition, the pre-scalar datum 14 is also for calculating brightness values according to the display data 16 at a predetermined clock. The plurality of display data 16 includes n sets of pulse width modulation (PWM) data corresponding to the red, green, and blue light. The first display datum is the brightness data of the red, green, and blue light of the first light-emitting module of the light-emitting module string. Each light is represented in 10 bits for a total of 1024 levels of brightness, and 2³⁰=1.67×10⁹ levels for the three colors of light. Moreover, each light of the display datum starts with the characteristic sign “01” at the beginning, so each light of the display datum is 12 bits, and each display datum is 36 bits. If the light-emitting module string has n light-emitting modules connected in series, the display data 16 is 36*n bits. The end datum 18 is M bits, and all the bits of the end datum 18 are “0”. The functions of the end datum 18 are: 1. extension, and 2. adjustment of the length of the display signal 10 to match the frame period T.

In general, signal transmission can be divided into synchronous transmission and asynchronous transmission. The synchronous transmission has to transmit a synchronous clock at the same time, so an extra synchronize line is necessary. The asynchronous transmission can utilize a single signal line to transmit. For example, Manchester code could be utilized with a phase-locked loop (PLL) to read the data in the clock and latch the data by the clock, or a Biphase-M or Biphase-S code could also be used. The asynchronous transmission is mostly applied to low speed transmission. The preferred embodiment according to the present invention utilizes the synchronous transmission, but the asynchronous transmission is also within the scope of the present invention.

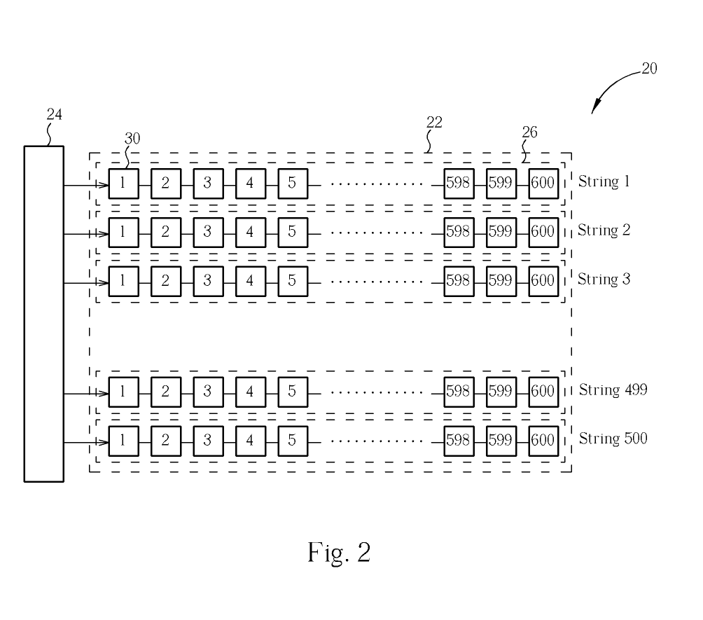

Please refer to FIG. 2. FIG. 2 is a diagram of a display system 20 according to the present invention. The display system 20 comprises a screen 22 and a display signal controller 24. The screen 22 comprises a plurality of light-emitting module strings 26. Each light-emitting module string 26 comprises a plurality of light-emitting modules 30 connected in series. The resolution of the screen 22 is 600*500 pixels. If an image is displayed in the screen at a frame rate of 30 frames per second (fps), each frame comprises 500 rows corresponding to the 500 rows of the light-emitting module string 26, and each light-emitting module string 26 has 600 light-emitting modules 30. The period T of the frame rate is 33.333 ms ( 1/30 s), the clock frequency f of the display system 20 is 800 kHz, and the clock period t of the display system 20 is 1.25 μs. So the end datum M of the display signal 10 for the display system 20 can be estimated by Formula (1) below. The display signal 10 is transmitted to each light-emitting module string 26 by synchronous transmission.

T=t×(16+12+3×12×600+M)=33.333 ms Formula (1)

In Formula (1), M=5038 (5038.4 rounded to the nearest integer). In the PWM data for displaying brightness of the display signal 10, if a frame period is 33.333 ms, to display 1024 grayscales, the period of the PWM data for each grayscale is 33.333 ms/1024=32.55 μs. Therefore, the pulse width counter 42 has to input a counter clock, and the period of the counter clock is equal to 26 clock periods of the display system 20. The pre-scalar counter 47 can generate the clock of the PWM data with a pre-scalar (value=26), and the pre-scalar can be read in the display data 10.

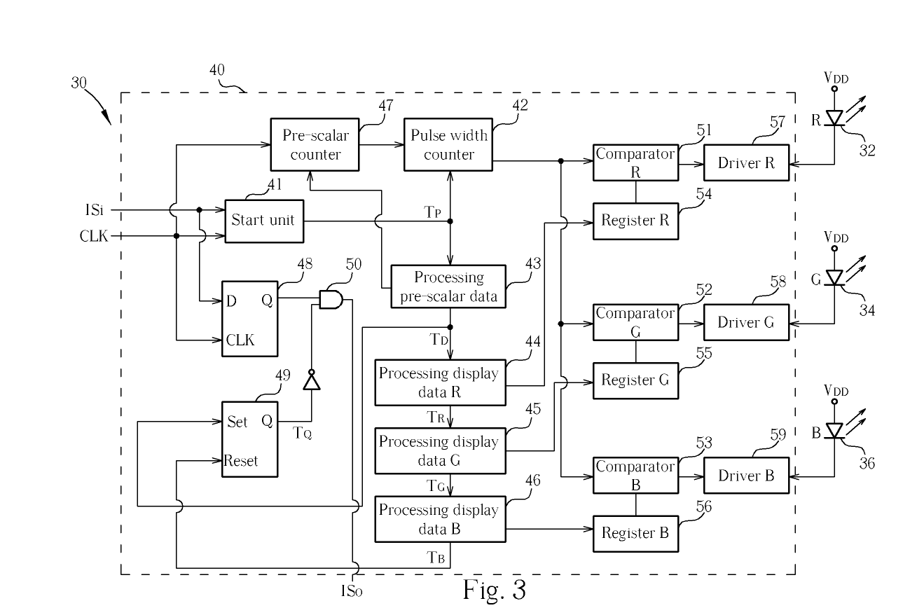

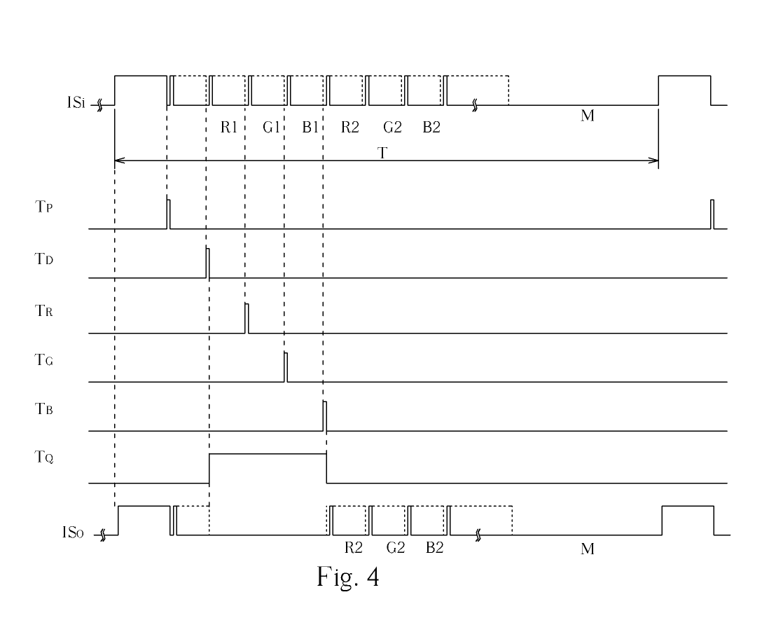

Please refer to FIG. 3 and FIG. 4. FIG. 3 is block diagram of the light-emitting module 30 in FIG. 2. FIG. 4 is a waveform diagram of signals in FIG. 3. The light-emitting module 30 includes a red light 32, a green light 34, a blue light 36, and a logic circuit 40. The logic circuit 40 includes a start unit 41, a pulse width counter 42, a first data processing unit 43, a second data processing unit 44, a third data processing unit 45, a fourth data processing unit 46, a pre-scalar counter 47, a first flip-flop 48, a second flip-flop 49, an AND gate 50, a first comparator 51, a second comparator 52, a third comparator 53, a first register 54, a second register 55, a third register 56, a first light driver 57, a second light driver 58, and a third light driver 59. When the start unit 41 receives 16 successive 1's, that means the start datum 12 of the display signal 10 is received, so a trigger signal Tp is generated. The trigger signal Tp drives the first to fourth data processing units 43, 44, 45, 46 to transmit the saved data to the pre-scalar counter 47, and to the first to third registers 54, 55, 56, respectively. In addition, the trigger signal Tp starts the 10-bit pulse width counter 42. The pulse width counter 42 receives the output clock of the pre-scalar counter 47 and generates a 10-bit count value. The count value is transmitted to the first to third comparators 51, 52, 53 and compared with the data saved in the first to third registers 54, 55, 56, respectively, so as to generate the PWM data for controlling the first light driver 57, the second light driver 58, and the third light driver 59 for displaying an image on the screen 22.

At the same time, the trigger signal Tp drives the first data processing unit 43 to receive the pre-scalar datum 14 for the next frame. The first data processing unit 43 removes the characteristic sign “01” at the beginning of the pre-scalar datum 14, and uses the following 10 bits of data as a pre-scalar value. After receiving the pre-scalar datum 14, the first data processing unit 43 generates a trigger signal TD to start the second data processing unit 44. The second data processing unit 44 utilizes the characteristic sign “01” to acquire 10 bits of display data of the red light. After receiving the display data of the red light, the second data processing unit 44 generates a trigger signal TR to start the third data processing unit 45. Similarly, the third data processing unit 45 utilizes the characteristic sign “01” to acquire the display data of the green light, and then generates a trigger signal TG to start the fourth data processing unit 46. The fourth data processing unit 46 utilizes the characteristic sign “01” to acquire the display data of the blue light. The trigger signal TD disables the second flip-flop 49, and the second flip-flop 49 generates a disable signal TQ for updating the corresponding display data. After acquiring the display data of the blue light, the fourth data processing unit 46 generates a trigger signal TB to reset the second flip-flop 49. The trigger signal Tp is generated once per frame, so the trigger signal TD, the trigger signal TR, the trigger signal TG, and the trigger signal TB are only generated once. Therefore, the display data following the second display data is outputted from the AND gate 50 and is not updated. As shown in FIG. 4, in comparison with the input display signal ISi, in the output display signal ISo only the data of R1G1B1 are updated to “0” and others are not updated. Because the first flip-flop 48 outputs data synchronously, the output display signal ISo will lag one synchronous clock behind the input display signal ISi. The output display signal ISo is transmitted to the next light-emitting module as an input signal. For example, the second light-emitting module receives the output signal from the first light-emitting module. Then, the second data processing unit 44 of the second light-emitting module utilizes the characteristic sign “01” to acquire the display data R2, and the third data processing unit 45 acquires the display data G2, and the fourth data processing unit 46 acquires the display data B2. Basically, the functions of the logic circuit 40 are the same in each light-emitting module.

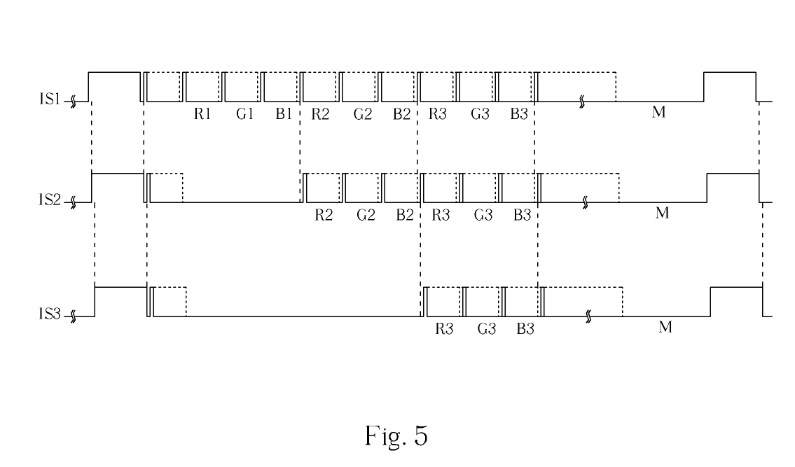

Please refer to FIG. 5. FIG. 5 is a diagram of the light-emitting module 30 transmitting the display signal. The display signal IS1 is the input signal of the first light-emitting module. The display signal IS2 is the output signal of the first light-emitting module, and is also the input signal of the second light-emitting module. The display signal IS3 is the output signal of the second light-emitting module. The display signal IS2 lags one clock behind the display signal IS1, and the display signal IS3 lags one clock behind the display signal IS2. The first light-emitting module receives the display signal IS1 processed by the logic circuit 40 of the first light-emitting module, and outputs the display signal IS2 whose R1G1B1 data has been updated to “0”. Then, the display signal IS2 is transmitted to the second light-emitting module, and processed by the logic circuit 40 of the second light-emitting module. Similarly, the second light-emitting module outputs the display signal IS3 whose R2G2B2 data has been updated to “0”. As mentioned above, it is possible to use a single signal line to transmit the display signal IS1 to the light-emitting module string 26, and the light-emitting module string 26 also can transmit the display signal in series to each light-emitting module. The logic circuit 40 of each light-emitting module can read corresponding display data and generate the PWM display data for the red, green, and blue light in the frame period T so as to display the image. In the preferred embodiment according to the present invention, light-emitting diodes (LED) provide the red, green, and blue light. In the light-emitting module string having 600 light-emitting modules, the first light-emitting module and the last light-emitting module are separated by 600 synchronous clock periods. The time difference is approximately 0.75 ms (600*1.25 us), which is indistinguishable by the human eye, so corrections are unnecessary.

In summary, the present invention provides a method for processing display signals of a light-emitting module string, utilizing a single signal line to transmit the display signals to the light emitting module string. A first light-emitting module of the light emitting module string receives and updates the display signal, and transmits the updated display signal to a second light-emitting module. Finally, the display signal is transmitted to the last light-emitting module of the light emitting module string. Each light-emitting module of the light emitting module string includes a logic circuit for transmitting, receiving, and updating the data of the display signal. The display signal is transmitted from the first light-emitting module to the last light-emitting module in sequence. Therefore, each logic circuit is the same and adapted to mass production. Accordingly, the display system of the present invention can use the single signal to transmit the display signal to the light-emitting module string, and the display signal is transmitted to each light-emitting module connected in series. Each light-emitting module has a logic circuit which can read the corresponding display data and generate the PWM data in the frame period to drive the lights displaying the image.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for processing display signals of a light-emitting module string comprising:
providing a light-emitting module string having a plurality of light-emitting modules connected in series;
transmitting a display signal having a plurality of display data to a first light-emitting module of the light-emitting module string;
the first light-emitting module receiving a first display datum of the display signal;
updating the first display datum of the display signal; and
transmitting a result of updating the first display datum to a second light-emitting module of the light-emitting module string.

2. The method of claim 1 wherein updating the first display datum of the display signal is the first light-emitting module updating the first display datum of the display signal after receiving the first display datum of the display signal.

3. The method of claim 1 further comprising:
the second light-emitting module receiving a second display datum of the display signal; and
updating the second display datum of the display signal.

4. The method of claim 3 wherein updating the second display datum of the display signal is the second light-emitting module updating the second display datum of the display signal after receiving the second display datum of the display signal.

5. The method of claim 1 wherein transmitting the display signal having the plurality of display data to the first light-emitting module of the light-emitting module string is transmitting a pulse width modulation (PWM) signal having the plurality of display data to the first light-emitting module of the light-emitting module string.

6. The method of claim 1 wherein updating the first display datum of the display signal is updating the first display datum of the display signal to “0”.

7. The method of claim 1 wherein updating the first display datum of the display signal is updating the first display datum of the display signal to “1”.

8. The method of claim 1 further comprising synchronizing the display signal when receiving a start datum of the display signal.

9. The method of claim 8 further comprising recognizing the display signal according to the start datum and a characteristic sign following the start datum.

10. The method of claim 9 further comprising calculating brightness of the plurality of display data at a predetermined clock according to a pre-scalar following the characteristic sign.

11. The method of claim 9 wherein transmitting the display signal having the plurality of display data to the first light-emitting module of the light-emitting module string is transmitting the display signal having the plurality of display data led by the characteristic sign to the first light-emitting module of the light-emitting module string.

12. The method of claim 1 further comprising adjusting a length of the display signal to synchronize with a period of a frame according to a backup datum of the display signal.

13. The method of claim 1 wherein providing the light-emitting module string having the plurality of light-emitting modules connected in series is providing a light-emitting diode (LED) module string having a plurality of LED modules connected in series.

14. The method of claim 1 wherein providing the light-emitting module string having the plurality of light-emitting modules connected in series is providing the light-emitting module string having the plurality of light-emitting modules connected in series, wherein each light-emitting module comprises a red light, a green light, a blue light, and a logic circuit.

15. The method of claim 14 wherein updating the first display datum of the display signal is utilizing the logic circuit of the first light-emitting module to update the first display datum of the display signal.

16. A display system capable of processing display signals of a light-emitting module string comprising:
a screen comprising a plurality of light-emitting module strings, each light-emitting module string comprising a plurality of light-emitting modules connected in series; and
a display signal controller coupled to the plurality of light-emitting module strings for transmitting a display signal having a plurality of display data to a first light-emitting module of the light-emitting module string;
wherein each first light-emitting module of the light-emitting module string comprises means for updating a first display datum of the display signal after receiving the first display datum of the display signal, and transmitting a result of updating the first display datum of the display signal to a next light-emitting module connected in series.

17. The display system of claim 16 wherein the display signal comprises a start datum, a characteristic sign, a pre-scalar, and a backup datum.

18. The display system of claim 16 wherein each light-emitting module comprises a red light, a green light, and a blue light.

19. The display system of claim 16 wherein the light-emitting module is light-emitting diode (LED) module.

20. The display system of claim 16 wherein the display signal is a pulse width modulation (PWM) signal.
